(19) United States
(12) Patent Application Publication
(10) Pub. No.: US 2009/0008181 A1
(43) Pub. Date: Jan. 8, 2009

(54) MOTORCYCLE AIRBOX WITH A HELMHOLTZ RESONATOR

(76) Inventors: Paul Pedersen, Germantown, WI (US); Brian Freeh, Elkhorn, WI (US); Matthew J. Sheahan, Milwaukee, WI (US); Anthony D. Stefanelli, Elkhorn, WI (US)

Correspondence Address: MICHAEL BEST & FRIEDRICH LLP, 100 E WISCONSIN AVENUE, Suite 3300, MILWAUKEE, WI, 53202, US

(21) Appl. No.: 11/772,488

(22) Filed: Jul. 2, 2007

(51) Int. Cl. B62D 61/02; B60K 11/00

(52) U.S. Cl. 180/229; 180/68.1

(57) ABSTRACT

An air intake assembly for an engine of a motorcycle includes an air intake opening for receiving intake air, the intake air defining an air flow direction. The air intake assembly further includes an airbox at least partially defining a chamber. A partition is positioned within the chamber dividing the chamber into an expansion chamber in communication with and downstream of the air intake opening and a sub-chamber configured to reduce the noise associated with the flow of intake air through the air intake assembly during operation of the engine.

### BACKGROUND

The present invention relates to an air intake configuration for a motorcycle engine. More particularly, the invention relates to a high flow, noise-reducing airbox assembly and a motorcycle incorporating the same.

### SUMMARY

In one embodiment, the invention provides an air intake assembly for an engine of a motorcycle. The air intake assembly includes an air intake opening for receiving intake air, the intake air defining an air flow direction. The air intake assembly further includes an airbox at least partially defining a chamber. A partition is positioned within the chamber dividing the chamber into an expansion chamber in communication with and downstream of the air intake opening and a sub-chamber configured to reduce the noise associated with the flow of intake air through the air intake assembly during operation of the engine.

In another embodiment, the invention provides an airbox for a motorcycle including a lower wall at least partially forming a chamber, the lower wall having an inlet opening and an outlet opening. The airbox further includes a partition positioned between the lower wall and the upper wall. The partition divides the chamber into a Helmholtz resonator sub-chamber and an expansion chamber including the inlet opening.

Other aspects of the invention will become apparent by consideration of the detailed description and accompanying drawings.

### BRIEF DESCRIPTION OF THE DRAWINGS

FIG. 1 is a side view of a motorcycle including an airbox according to one embodiment of the present invention.

FIG. 2 is an exploded assembly view of the airbox of FIG. 1.

FIG. 3 is a perspective view of the airbox of FIG. 1 with a cover removed to show the interior chamber.

FIG. 4 is a front view of the airbox of FIG. 1.

FIG. 5 is a side view of the airbox of FIG. 1.

FIG. 6 is a schematic view of the airbox.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

### DETAILED DESCRIPTION

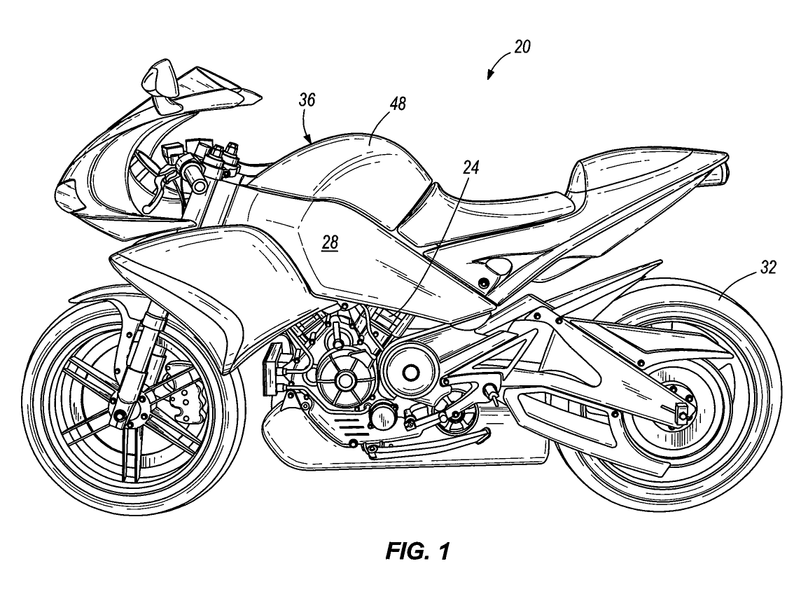

FIG. 1 illustrates a motorcycle 20 having an engine 24 mounted on a frame 28. The engine 24 is of a V-twin configuration and is configured to provide power to a rear wheel 32 of the motorcycle 20. During operation of the engine 24, air is drawn into the engine 24 for combustion through an airbox 36. A filter element 40 is mounted inside the airbox 36 to remove impurities of the intake air before it is combusted with fuel in the engine 24.

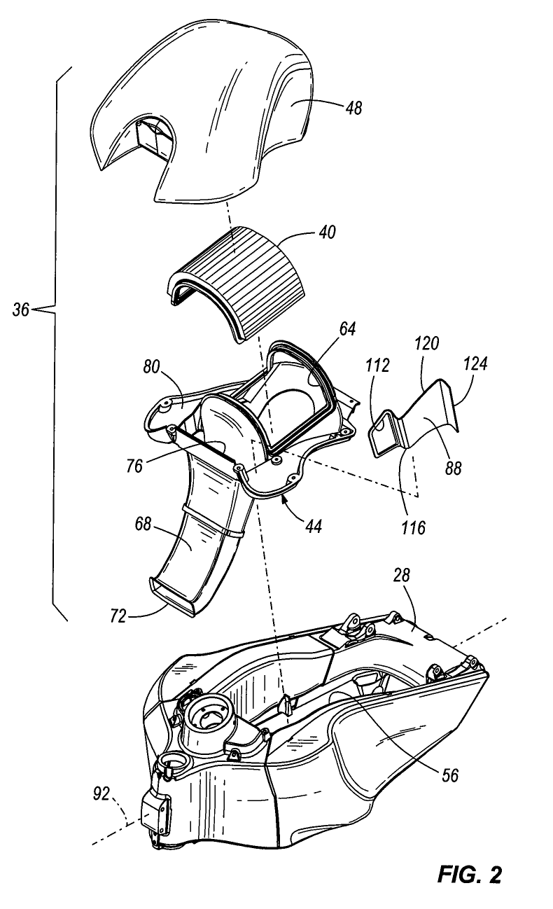

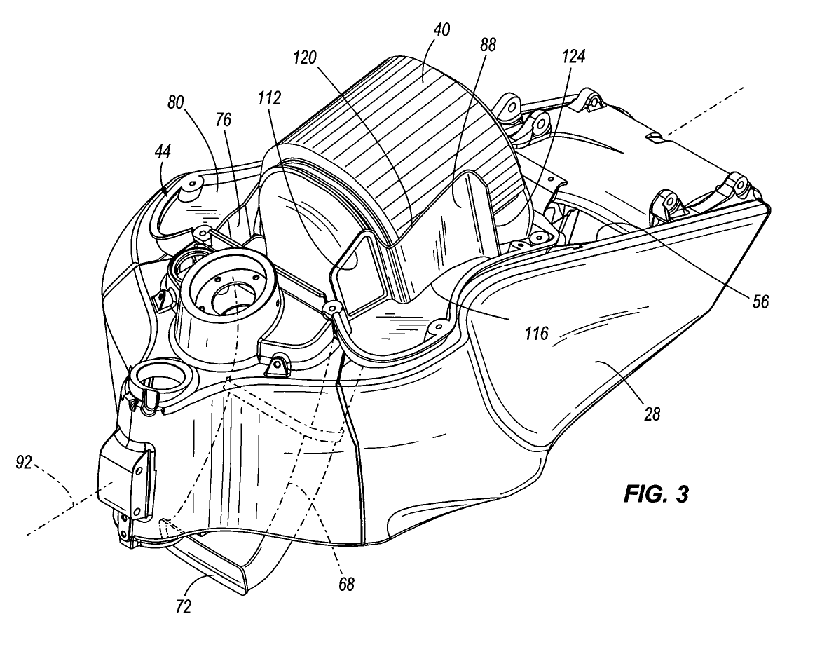

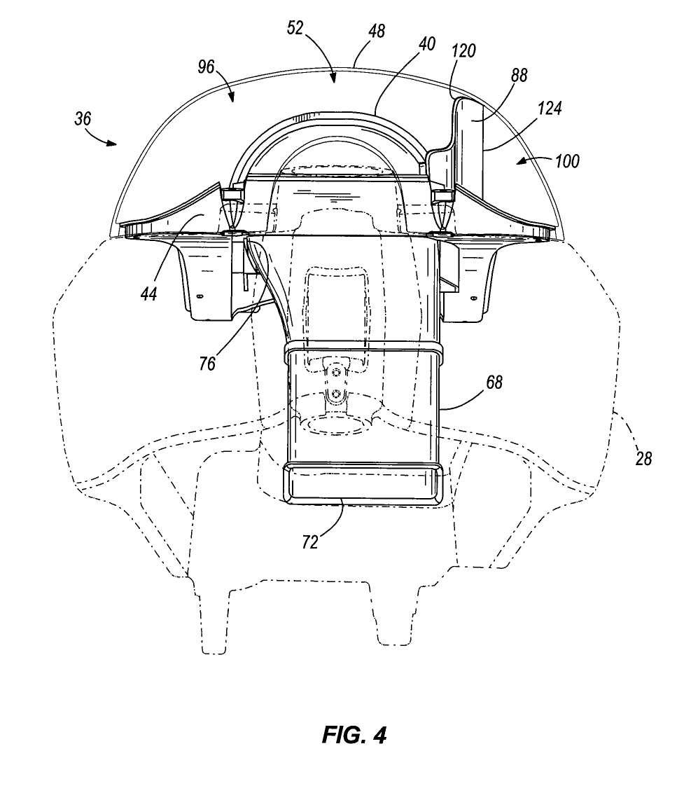

Referring to FIG. 2, the airbox 36 includes a lower tub 44 defining a lower wall and a cover 48 defining an upper wall. Each of the lower wall and the upper wall at least partially defines an interior space or chamber 52 of the airbox 36 (FIGS. 4-6). As shown in FIGS. 2-3, the lower tub 44 is arranged within an opening 56 of the frame 28, at a forward end thereof. In this position, the chamber 52 is located over the engine 24. The filter element 40 is mounted in an outlet opening 64 (FIG. 2) formed in the lower tub 44 so that intake air passes through the filter element 40 and out of the chamber 52 toward the engine 24 in a substantially downward direction. In some embodiments, the filter element 40 is positioned at another location upstream of the engine 24, for example upstream of the airbox 36 or at another location within the airbox 36. The lower tub 44 is substantially form-fitting with the frame 28 and coupled thereto. The cover 48 is coupled to the lower tub 44 around a mutual periphery. Additional components, such as sealing or bonding materials, gaskets, fasteners, etc. are used in some embodiments to assemble and/or seal the airbox 36. In some embodiments, the chamber 52 is at least partially formed by two or more components such as lateral halves, forward/rearward halves, etc. In such embodiments, each of the lower wall and the upper wall of the chamber 52 can be formed by two or more airbox components.

As shown in FIGS. 2-5, an intake pipe 68 is connected to the lower tub 44 to direct intake air into the airbox chamber 52. The intake pipe 68 can be partially or wholly integrated (e.g., molded as one piece) with the lower tub 44. The intake pipe 68 extends downwardly and forwardly from the airbox chamber 52. In the illustrated embodiment, the intake pipe 68 has a forwardly-facing inlet opening 72, which is configured to increase ram air into the airbox 36.

The intake pipe 68 opens into the chamber 52 at an inlet opening 76 that is arranged adjacent the forward end of the lower tub 44. As best shown in FIGS. 2 and 3, the inlet opening 76 is formed in a bottom surface 80 of the lower tub 44 such that the intake air moves substantially upward upon entry into the chamber 52. The flow of air from the inlet opening 76 into the chamber 52 constitutes a transition zone configured to allow the flow of intake air to expand into the larger volume of the chamber 52. As best shown in FIG. 4, the inlet opening 76 fans out significantly in a lateral direction at the transition zone, having a cross-sectional area that becomes increasingly greater than that of the intake pipe 68 as the inlet opening 76 opens into the chamber 52.

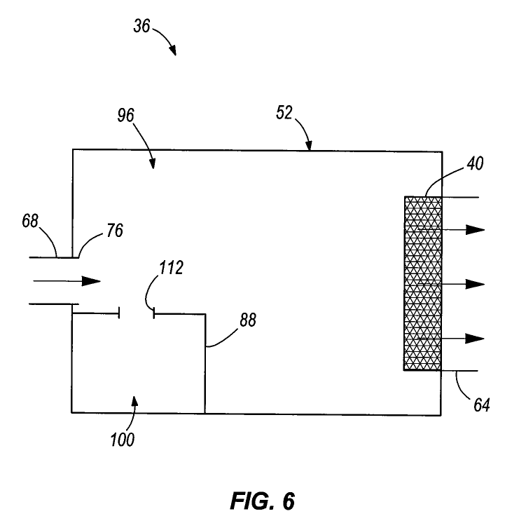

A partition, such as a partition wall 88 is positioned within the chamber 52, substantially between the lower wall and the upper wall (e.g., between the lower tub 44 and the cover 48). The partition wall 88 is positioned substantially vertically and to one side of an imaginary centerline 92 of the motorcycle (FIGS. 2 and 3). In some embodiments, the partition extends generally laterally, diagonally, etc. within the chamber 52. The partition wall 88 divides the chamber 52 into a first volume (e.g., expansion chamber 96) and a second volume (e.g., sub-chamber 100). The sub-chamber 100, which is smaller than the expansion chamber 96, is specifically tuned and configured to alter the flow of the intake air through the airbox 36 and the sound produced by the intake air flow. In some embodiments, the partition is substantially non-planar and/or the partition itself defines a partially enclosed space to partially or wholly define the sub-chamber 100. The sub-chamber 100 is configured as a Helmholtz resonator to reduce the noise generated by the flow of intake air through the airbox 36. The airbox 36 is schematically illustrated in FIG. 6.

The partition wall 88 is formed with an opening 112, which defines an interface of fluid communication between the expansion chamber 96 and the Helmholtz resonator sub-chamber 100. Alternately, the interface between the expansion chamber 96 and the Helmholtz resonator sub-chamber 100 is at least partially defined by the cover 48 and/or the lower tub 44. The opening 112 in the partition wall 88 is positioned adjacent the transition zone where the inlet opening 76 opens from the intake pipe 68 into the expansion chamber 96.

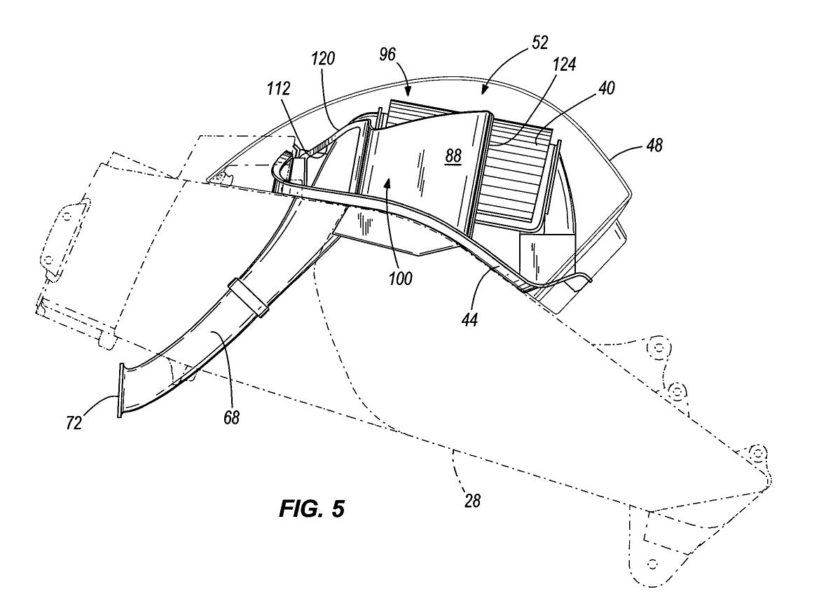

The partition wall 88 is mounted inside the chamber 52 with a first edge portion 116 in contact with the lower tub 44 and a second edge portion 120 in contact with the cover 48 (FIGS. 3-5). A third edge portion 124 contacts both the lower tub 44 and the cover 48. In this manner, the entire periphery of the partition wall 88 is in contact with one surface or another that defines the chamber 52, in a substantially sealing relationship. FIGS. 4 and 5 illustrate the cover 48 as being generally transparent for enhanced clarity. In practice, the airbox cover 48 can be transparent, semi-transparent, opaque, etc. In some embodiments, one or more sealing members are interposed between the partition wall 88, or portions thereof, and the lower tub 44 and/or cover 48 to provide a substantially leak-free partition between the expansion chamber 96 and the Helmholtz resonator sub-chamber 100, except at the designated interface opening 112.

The partition wall 88 is mounted inside the chamber 52 by a friction fit such that the partition wall 88 is removable when the cover 48 is removed from the lower tub 44. When the cover 48 is mounted on the lower tub 44, the partition wall 88 is automatically positioned in a sealed relationship with the lower tub 44 and the cover 48. Alternately, one or more fasteners and/or one or more adhesive or cohesive bonding agents and/or snaps, clips, rivets, etc. can be used in mounting the partition wall 88 inside the chamber 52, either removably or semi-permanently.

In some embodiments, the partition wall 88 is integrally-formed as a single piece with the lower tub 44. As such, the partition wall 88 remains in place when the cover 48 is removed from the lower tub 44 (e.g., to service and/or replace the filter element 40). Alternately, the partition wall 88 can be integrally-formed as a single piece with the cover 48. In such embodiments, the partition wall 88 is removed from the lower tub 44 when the cover 48 is removed from the lower tub 44.

As the engine 24 operates, intake air is drawn from the atmosphere into the intake pipe 68 through the inlet opening 72. The flow of intake air expands at the transition zone as it reaches the inlet opening 76 of the chamber 52. Inside the chamber 52, the expansion chamber 96 provides for a large capacity of intake air to pass through the filter element 40 toward the engine 24 for combustion. A portion of the flow of intake air passes through the opening 112 and enters the Helmholtz resonator sub-chamber 100, which is a dead end passage. That portion of the flow of intake air reflects off the sub-chamber walls and returns to the expansion chamber 96 through the opening 112, interacting with the incoming intake air from the intake pipe 68 to cancel out selected sound pressure waves inside the chamber 52. This acts to quiet the overall noise level of the engine 24 associated with the airbox 36.

Because the Helmholtz resonator sub-chamber 100 is formed as a relatively small portion of the chamber 52 arranged off to one side of the chamber 52 near the inlet opening 76, the remainder of the chamber 52 (i.e., the expansion chamber 96) facilitates a high flow rate of intake air for enhanced performance of the engine 24.

Thus, the invention provides, among other things, an airbox 36 for a motorcycle 20 having a chamber 52 divided into a Helmholtz resonator sub-chamber 100 and an adjacent expansion chamber 96, the chamber 52 being divided by a partition wall 88. Various features and advantages of the invention are set forth in the following claims.

What is claimed is:

1. An air intake assembly for an engine of a motorcycle, the air intake assembly comprising:
an air intake opening for receiving intake air, the intake air defining an air flow direction;
an airbox at least partially defining a chamber; and
a partition positioned within the chamber dividing the chamber into an expansion chamber in communication with and downstream of the air intake opening and a sub-chamber configured to reduce the noise associated with the flow of intake air through the air intake assembly during operation of the engine.

2. The air intake assembly of claim 1, wherein the sub-chamber is a Helmholtz resonator.

3. The air intake assembly of claim 1, wherein the partition at least partially defines an opening of the sub-chamber, the opening being positioned at an upstream end of the chamber.

4. The air intake assembly of claim 3, further comprising a sealing member positioned adjacent the partition to substantially seal the sub-chamber from the expansion chamber except for the opening of the sub-chamber.

5. The air intake assembly of claim 3, wherein the opening of the sub-chamber is positioned adjacent a transition zone where the air intake opening meets the chamber.

6. The air intake assembly of claim 1, wherein the expansion chamber is positioned over the engine.

7. The air intake assembly of claim 1, wherein the partition is removably positioned within the chamber.

8. An airbox for a motorcycle comprising:
a lower wall at least partially forming a chamber, the lower wall having an inlet opening and an outlet opening;
an upper wall coupled to the lower wall and at least partially forming the chamber; and
a partition positioned between the lower wall and the upper wall, the partition dividing the chamber into a resonator sub-chamber and an expansion chamber.

9. The airbox of claim 8, wherein the partition is removably positioned in the airbox chamber.

10. The airbox of claim 8, further comprising a sealing member positioned around a substantial portion of a periphery of the partition.

11. The airbox of claim 8, wherein the inlet opening of the lower wall is coupled to an air intake pipe having a smaller cross-sectional area than the inlet opening.

12. The airbox of claim 8, wherein the partition at least partially defines a sub-chamber opening between the resonator sub-chamber and the expansion chamber.

13. The airbox of claim 12, wherein the sub-chamber opening is positioned at an upstream end of the chamber.

14. The airbox of claim 12, wherein the sub-chamber opening is positioned adjacent the inlet opening of the lower wall.

15. A motorcycle comprising:
a frame;
an airbox coupled to the frame, the airbox defining a chamber; and
a partition positioned within the chamber, the partition dividing the chamber into an expansion chamber and a resonator sub-chamber.

16. The motorcycle of claim 15, further comprising an air intake pipe in communication with the expansion chamber, the air intake pipe having an inlet opening.

17. The motorcycle of claim 15, wherein an inlet opening of the chamber is formed at an upstream end the airbox.

18. The motorcycle of claim 17, wherein the partition at least partially defines a sub-chamber opening adjacent the inlet opening of the chamber.

19. The motorcycle of claim 15, further comprising an engine, wherein the expansion chamber is positioned substantially over the engine.

20. The motorcycle of claim 15, wherein the partition is removably positioned within the chamber.
